(19) United States
(12) Patent Application Publication
(10) Pub. No.: US 2012/0012630 A1
(43) Pub. Date: Jan. 19, 2012

(54) CHARGER BELT

(75) Inventors: Mun Pook Lui, Northridge, CA (US); Jeffery V. Funderburk, Stevenson Ranch, CA (US); Joey Chen, Valencia, CA (US)

(73) Assignee: BOSTON SCIENTIFIC NEUROMODULATION CORPORATION, Valencia, CA (US)

(21) Appl. No.: 13/184,228

(22) Filed: Jul. 15, 2011

Related U.S. Application Data
(60) Provisional application No. 61/364,732, filed on Jul. 15, 2010.

(51) Int. Cl. A45F 3/00; B23P 19/04

(52) U.S. Cl. 224/660; 224/101; 29/428

(57) ABSTRACT

Electrical energy is transcutaneously transmitted from an external charger to an implanted medical device, wherein the external charger includes a charger head that is positioned on the patient to align with the implanted medical device for efficient charging. To secure the charger head in alignment with the implanted medical device, a belt with a buckle is provided for securing the charger head. The belt is adjustable in length by sliding end portions of the belt through a buckle and joining respective fabrics on the belt. The position of the buckle can also be adjusted for ease of patient use. Additional features of the belt provide for heat management to improve patient comfort and an additional strap to further adjust the length of the belt.

### RELATED APPLICATION DATA

The present application claims the benefit under 35 U.S.C. §119 to U.S. provisional patent application Ser. No. 61/364,732, filed Jul. 15, 2010. The foregoing application is hereby incorporated by reference into the present application in its entirety.

### FIELD OF THE INVENTION

The present invention relates to apparatus and methods for charging implanted medical devices, and more particularly, to apparatus and methods for holding chargers to charge implanted medical devices.

### BACKGROUND OF THE INVENTION

Implantable stimulation devices are devices that generate and deliver electrical stimuli to body nerves and tissues for the therapy of various biological disorders, such as pacemakers to treat cardiac arrhythmia, defibrillators to treat cardiac fibrillation, cochlear stimulators to treat deafness, retinal stimulators to treat blindness, muscle stimulators to produce coordinated limb movement, spinal cord stimulators to treat chronic pain, cortical and deep brain stimulators to treat motor and psychological disorders, and other neural stimulators to treat urinary incontinence, sleep apnea, shoulder sublaxation, etc. The present invention may find applicability in all such applications, although the description that follows will generally focus on the use of the invention within a spinal cord stimulation system, such as that disclosed in U.S. Pat. No. 6,516,227 (“the '227 patent”), issued Feb. 4, 2003 in the name of inventors Paul Meadows et al., which is incorporated herein by reference in its entirety.

To further illustrate, spinal cord stimulation is a well-accepted clinical method for reducing pain in certain populations of patients. A spinal cord stimulation (SCS) system typically includes an implantable pulse generator and at least one stimulation electrode lead that carries electrodes arranged in a desired pattern and spacing to create an electrode array. Individual wires within the electrode lead(s) connect with each electrode in the array. The electrode lead(s) is typically implanted along the dura of the spinal cord, with the electrode lead(s) exiting the spinal column, where it can generally be coupled to one or more electrode lead extensions. The electrode lead extension(s), in turn, are typically tunneled around the torso of the patient to a subcutaneous pocket where the implantable pulse generator is implanted. Alternatively, the electrode(s) lead may be directly coupled to the implantable pulse generator. For examples of other SCS systems and other stimulation systems, see U.S. Pat. Nos. 3,646,940 and 3,822,708, which are hereby incorporated by reference in their entireties.

Of course, implantable pulse generators are active devices requiring energy for operation. Oftentimes, it is desirable to recharge an implanted pulse generator via an external charger, so that a surgical procedure to replace a power depleted implantable pulse generator can be avoided. To wirelessly convey energy between the external charger and the implanted pulse generator, the recharger typically includes an alternating current (AC) charging coil that supplies energy to a similar charging coil located in or on the implantable pulse generator. This system is like a loosely coupled inductive transformer where the primary coil is in the external charger and the secondary coil is in the implanted pulse generator. The energy received by the charging coil located on the implantable pulse generator can then be used to directly power the electronic componentry contained within the pulse generator, or can be stored in a rechargeable battery within the pulse generator, which can then be used to power the electronic componentry on-demand.

To provide efficient power transmission through tissue from the external charger to the implanted pulse generator, it is paramount that the charging coil located in or on the implantable pulse generator be spatially arranged relative to the corresponding AC coil of the external charger in a suitable manner. That is, efficient power transmission through the patient's skin from the external charger to the implantable pulse generator via inductive coupling requires constant close alignment between the two devices. Thus, efficiency of the coupling between the external charger and implantable pulse generator is largely dependent upon the alignment between the two coils, and in part, determines what is known as the coupling factor k in a transformer. Achieving a good coupling factor is essential for optimizing efficiency of the inductive link between the external charger and implantable pulse generator. Not only does good coupling increase the power transferred from the external charger to the implantable pulse generator, it minimizes heating in the implantable pulse generator, and also reduces the power requirements of the external charger, which reduces heating of the external charger and minimizes the smaller form factor of the external charger. Proper coupling is also essential for the charging system to function properly, since sufficient coupling is also required for data transfer during the charging process.

In one method to achieve constant close alignment between the external charger and the implantable pulse generator, the external charger is secured to a belt that wraps around an external area of the patient. A typical belt has a buckle on one end of the belt, wherein the opposite end of the belt is slid through the buckle. The belt can be adjusted around the patient such that the charger aligns with the implantable pulse generator, which is typically implanted within the lower back just above one of the buttocks of the patient. However, such belts are often only readily adjustable to position the charger on one side of the patient, usually the left side of the patient. For patients with implantable pulse generators on the right side, it can be very inconvenient and uncomfortable to try adjusting the belt to align the external charger with the implantable pulse generator.

Additionally, a typical belt is limited in that the buckle is configured to receive only one end of the belt to adjust the belt, e.g., a belt may be configured to receive a left end of the belt that is slid through the buckle with the patient's left hand, while the patient holds the buckle in the right hand. However, if the end of the belt that is slid through the buckle is positioned on an incapacitated side of the patient, or if it is simply awkward for the patient to maneuver that end of the belt to adjust the belt and position the charger, then the belt becomes problematic for the patient to use.

Also, a patient may need to trim the belt in order to achieve the proper belt length for easy adjustment. This not only creates an extra fitting step for the patient, but also creates the possibility that the belt will not fit the patient correctly if the patient cuts the belt too short or otherwise gains weight after the belt has been cut to a previously-desired length. To allow for additional adjustment of the belt length, many such belts are made with a stretchable fabric. However, as the fabric stretches during wear, the belt is likely to become misaligned with the implantable pulse generator, and the fabric is likely to lose elasticity after continued use.

Regarding patient comfort, during the charging process, an external charger may become quite warm or even hot to the touch. In this situation, the belt may not provide a sufficient barrier to prevent serious heat discomfort to the patient. To compensate, the patient would need to adjust the position of the belt and charger, or move the belt and charger away from the patient's body. In turn, charging of the implantable pulse generator would become much less efficient. In other words, the only options the patient has for heat management result in a decrease in charging efficiency.

Thus, there remains a need for an improved apparatus and method for charging an implantable pulse generator with an external charger that allows for ease of adjustment in positioning the external charger and for sufficient heat management and overall comfort for the patient.

### SUMMARY OF THE INVENTION

In accordance with one aspect of the present inventions, a belt for securing an external device having an operative side from which energy can be transmitted to a medical device implanted within a patient is provided. The belt comprises a primary strap forming a length to encircle a body part of the patient. The primary strap has first and second opposing sides, a first end portion, a second end portion, and a central portion between the first and second end portions to which the external device can be secured. First and second fabrics are disposed on the first side of the primary strap respectively along a length of the first end portion and are configured for being removably adhered to each other. The belt also comprises a primary buckle with a first opening through which the first end portion of the primary strap can be slid and folded back onto itself, such that the first fabric adheres to the second fabric to adjust the length of the strap. The primary buckle is also configured to receive the second end portion of the primary strap to secure the belt to the body part of the patient.

In another embodiment, the primary strap of the belt comprises third and fourth fabrics disposed on the first side of the primary strap respectively along a length of the second end portion, wherein the third and fourth fabrics are configured for being removably adhered to each other. Additionally, the second end portion of the primary strap is configured for being slid through the primary buckle and folded back onto itself, such that the third fabric adheres to the fourth fabric to secure the belt to the body part of the patient. In another embodiment, the belt includes a pouch for securing the external device to the belt. Also in other embodiments, the belt comprises a thermal barrier and one or more spacers that are selectively removable by the patient and that are positioned between the patient and the external device.

In yet another embodiment, the belt comprises a secondary strap having third and fourth opposing sides, a third end portion, and a fourth end portion. Fifth and sixth fabrics are disposed on the third side of the secondary strap respectively along a length of the third end portion of the secondary strap, wherein the fifth and sixth fabrics are configured for being removably adhered to each other. The third end portion of the secondary strap is configured for being slid through the primary buckle and folded back onto itself, such that the fifth fabric adheres to the sixth fabric to secure the secondary strap to the primary strap. The secondary strap also comprises a secondary buckle attached to the fourth end portion and configured for receiving the second end portion of the primary strap to secure the belt to the body part of the patient.

In another aspect of the invention, a method is provided for using a strap having a primary strap and a primary buckle to secure an external device to a patient having an implanted medical device. The method comprises sliding one of first and second end portions of the primary strap through a first opening of the primary buckle and folding the one end portion of the primary strap back onto itself after it has been slid through the first opening of the primary buckle, thereby adjusting the length of the primary strap. Also, the folded end one portion of the primary strap is removably adhered to itself to affix the adjusted length of the primary strap, and the external device is secured to the primary strap. The primary strap with the adjusted length encircles the patient such that an operative side of the secured external device is located in proximity to the implanted medical device. Another of the first and second end portions of the primary strap is slid through the primary buckle to secure the belt to the body part of the patient.

Other and further aspects and features of the invention will be evident from reading the following detailed description of the preferred embodiments, which are intended to illustrate, not limit, the invention.

### BRIEF DESCRIPTION OF THE DRAWINGS

The drawings illustrate the design and utility of preferred embodiments of the present invention, in which similar elements are referred to by common reference numerals. In order to better appreciate how the above-recited and other advantages and objects of the present inventions are obtained, a more particular description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 is plan view of one embodiment of a spinal cord stimulation (SCS) system arranged in accordance with the present inventions;

FIG. 2 is a plan view of the SCS system of FIG. 1 in use with a patient;

FIG. 3 is a perspective view of one embodiment of an external charger used in the SCS system of FIG. 1;

FIG. 4 is a perspective view of one embodiment of a belt used on a patient with the SCS system of FIG. 1;

FIG. 5 is an alternate view of the embodiment of the belt shown in FIG. 4;

FIG. 6A is a perspective view of spacers used with the embodiment of the belt shown in FIG. 4;

FIG. 6B is a side cross-sectional view of one of the spacers shown in FIG. 6A inserted in the embodiment of the belt shown in FIG. 4

FIG. 7 is an embodiment of an additional strap used with the embodiment of the belt shown in FIG. 4.

FIG. 8 is a perspective view of the embodiment of the belt shown in FIG. 4 joined with the embodiment of the additional strap shown in FIG. 7;

FIG. 9 illustrates a method of using the embodiment of the belt shown in FIG. 4 to adjust the configuration of the belt;

FIG. 10 illustrates another method of using the embodiment of the belt shown in FIG. 4 to adjust the configuration of the belt on a patient;

FIG. 11 illustrates another aspect of the method illustrated in FIG. 10 to adjust the configuration of the belt on a patient;

FIG. 12 another method of using the embodiment of the belt shown in FIG. 4 to adjust the configuration of the belt on a patient;

FIG. 13 illustrates another aspect of the method illustrated in FIG. 12 to adjust the configuration of the belt on a patient;

FIG. 14 illustrates another aspect of the method illustrated in FIG. 12 to adjust the configuration of the belt on a patient;

FIG. 15 illustrates a method of securing the belt shown in FIG. 4 around a patient;

FIG. 16 illustrates another aspect of the method shown in FIG. 15 for securing the belt shown in FIG. 4 around a patient;

FIG. 17 illustrates another aspect of the method shown in FIG. 9 in which a spacer is inserted next to an external charging device in the belt; and

FIG. 18 illustrates a method of using the embodiment of the belt shown in FIG. 4 joined with the embodiment of the additional strap shown in FIG. 7 and adjusting the configuration of the belt.

### DETAILED DESCRIPTION OF THE EMBODIMENTS

At the outset, it is noted that the present invention may be used with an implantable pulse generator (IPG) or similar electrical stimulator, which may be used as a component of numerous different types of stimulation systems. The description that follows relates to a spinal cord stimulation (SCS) system. However, it is to be understood that while the invention lends itself well to applications in SCS, the invention, in its broadest aspects, may not be so limited. Rather, the invention may be used with any type of external charger used to charge implanted electrical circuitry in a patient. For example, the present invention may be used with any implanted, rechargeable, medical device, including a drug infusion pump, etc.

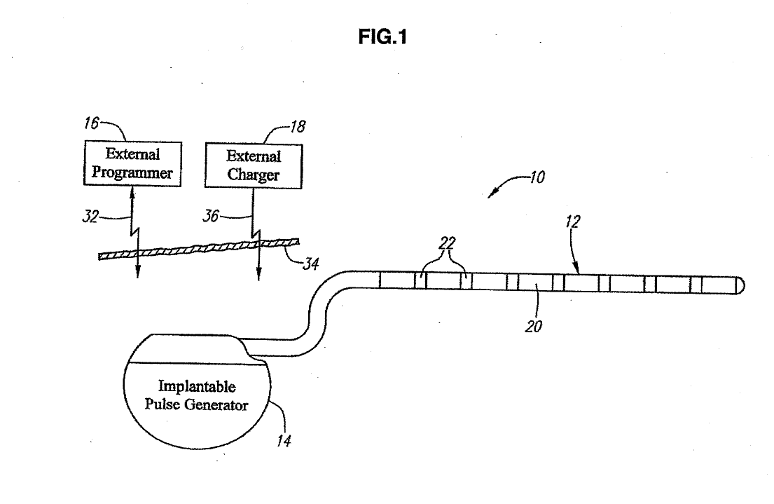

Turning first to FIG. 1, an exemplary SCS system 10 generally comprises an implantable neurostimulation lead 12, an implantable pulse generator (IPG) 14, an external (non-implanted) programmer 16, and an external (non-implanted) charger 18. In the illustrated embodiment, the lead 12 is a percutaneous lead and, to that end, includes a plurality of in-line electrodes 20 carried on a flexible body 22. Alternatively, the lead 12 may take the form of a paddle lead. The IPG 14 is electrically coupled to the lead 12 in order to direct electrical stimulation energy to each of the electrodes 20.

The IPG 14 includes an outer case formed from an electrically conductive, biocompatible material, such as titanium and, in some instances, will function as an electrode. The case forms a hermetically sealed compartment wherein the electronic and other components are protected from the body tissue and fluids. For purposes of brevity, the electronic components of the IPG 14 will not be described completely herein. Details of the IPG 14, including the battery, antenna coil, and telemetry and charging circuitry, are disclosed in U.S. Pat. No. 6,516,227, which is expressly incorporated herein by reference.

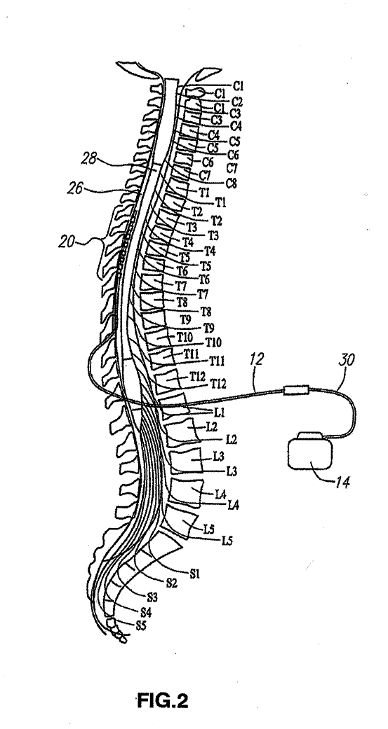

As shown in FIG. 2, the neurostimulation lead 12 is implanted within the epidural space 26 of a patient through the use of a percutaneous needle or other conventional technique, so as to be in close proximity to the spinal cord 28. Once in place, the electrodes 20 may be used to supply stimulation energy to the spinal cord 28 or nerve roots. The preferred placement of the lead 12 is such that the electrodes 20 are adjacent, i.e., resting upon, the nerve area to be stimulated. Due to the lack of space near the location where the lead 12 exits the epidural space 26, the IPG 14 is generally implanted in a surgically-made pocket either in the abdomen or above the buttocks. The IPG 14 may, of course, also be implanted in other locations of the patient's body, although the embodiment of the invention described herein is particularly useful when the IPG 14 is implanted adjacent the abdomen or buttocks of the patient. A lead extension 30 may facilitate locating the IPG 14 away from the exit point of the lead 12.

Referring back to FIG. 1, the IPG 14 is programmed, or controlled, through the use of the external programmer 18. The external programmer 18 is transcutaneously coupled to the IPG 14 through a suitable communications link (represented by the arrow 32) that passes through the patient's skin 34. Suitable links include, but are not limited to radio frequency (RF) links, inductive links, optical links, and magnetic links. For purposes of brevity, the electronic components of the external programmer 18 will not be described herein. Details of the external programmer, including the control circuitry, processing circuitry, and telemetry circuitry, are disclosed in U.S. Pat. No. 6,516,227, which has been previously incorporated herein by reference.

The external charger 18 is transcutaneously coupled to the IPG 14 through a suitable link (represented by the arrow 36) that passes through the patient's skin 34, thereby coupling power into the IPG 14 for the purpose of operating the IPG 14 or replenishing a power source, such as a rechargeable battery (e.g., a Lithium Ion battery), within the IPG 14. In the illustrated embodiment, the link 36 is an inductive link; that is, energy from the external charger 18 is coupled to the battery within the IPG 14 via electromagnetic coupling. Once power is induced in the charging coil in the IPG 14, charge control circuitry within the IPG 14 provides the power charging protocol to charge the battery.

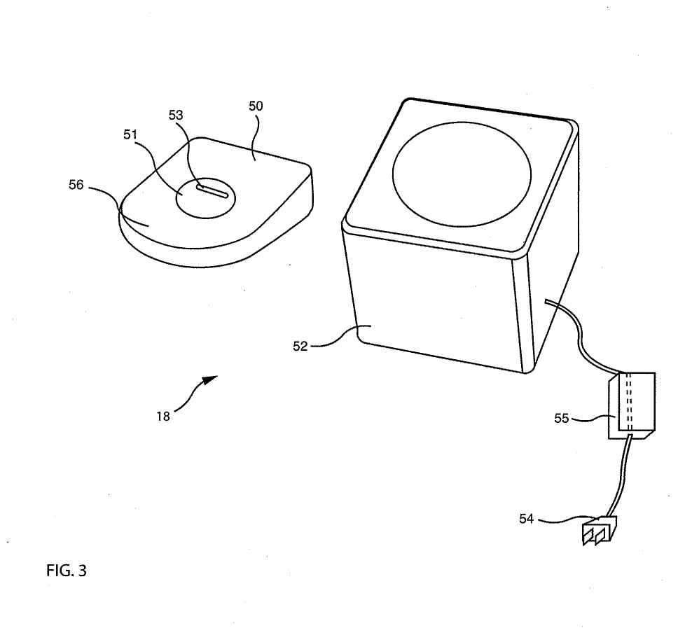

Referring now to FIG. 3, the external components of the external charger 18 will be described. In this embodiment, the external charger 18 takes the form of a two-part system comprising a portable charger 50 and a charging base station 52. The charging base station 52 includes an AC plug 54, so that it can be easily plugged into any standard 110 volt alternating current (VAC) or 200 VAC outlet. The charging base station 52 further includes an AC/DC transformer 55, which provides a suitable DC voltage (e.g., 5VDC) to the circuitry within the charging base station 52.

The portable charger 50 includes a housing 56 for containing circuitry, and in particular, the recharging circuitry, battery, and AC coil from which the charging energy is transmitted (not shown). For purposes of brevity, the recharging circuitry of the IPG 14 and portable charger 50 will not be described herein, but are disclosed in U.S. Provisional Application No. 61/119,671, which is incorporated herein by reference. The portable charger 50 further comprises an on/off button 51 that can be operated to selectively convey and cease conveying charging energy from the charger 50 through the side of the housing 56 opposite to the on/off button 51. The portable charger 50 further comprises a light emitting element, such as an LED that is visible through a slot 53 formed in the button 53 for providing operational status to the patient. The housing 56 is shaped and designed in a manner that allows the portable charger 50 to be detachably inserted into the charging base station 52, thereby allowing the portable charger 50, itself, to be recharged. Thus, both the IPG 14 and the portable charger 50 are rechargeable. The portable charger 50 may be returned to the charging base station 52 between uses. In an alternative embodiment, the charger 50 includes a separate charging head (not shown) connected to the housing 56 by way of a suitable flexible cable.

The external charger 18 is designed to charge the battery of the implanted IPG 14 to 80% capacity in two hours, and to 100% in three hours, at implant depths of up to 2.5 cm. For efficient transfer of energy to the IPG 14, it is important to properly align the charger 50 (or more particularly, the AC coil within the head 58) with the IPG 14. In one embodiment, the charger 50 generates an audible tone to indicate whether the charger 50 is properly aligned with the IPG 14, e.g., the audible tone sounds when the charger 50 is properly aligned with the IPG 14, or alternatively when the charger 50 is not properly aligned with the IPG 14.

Now referring to FIGS. 4-6, to help achieve and maintain proper alignment between the charger 50 and the IPG 14, a belt 70 is provided to securely position the charger 50 in proper alignment with the IPG 14. Significantly, the belt 70 is adjustable in length and capable of biasing the charger 50 to one side of the body part around which the belt 70 is secured, in order to align the charger 50 with the IPG 14 and thus optimize charging efficiency.

To this end, the belt 70 includes a primary strap 72 forming a length that encircles a body part of a patient. For example, the primary strap 72 can be configured for placement around a patient's waist, thigh, arm, or ankle based on the location of the IPG 14 within the patient. For purposes of illustration, the belt 70 is later described as encircling a patient's waist for use with the SCS system 10. In one embodiment, the primary strap 72 includes a substantially stretch-resistant fabric (not shown) to limit over-stretching of the belt 70 and to help the belt 70 maintain its size and structure.

The primary strap 72 has first and second opposing sides, 74, 76, respectively, wherein the first side 74, or front side, is designed to face outwardly from the patient, and the second side 76, or back side, is designed to face toward the patient. In one embodiment, the primary strap 72 includes a cushioned edge (not shown) extending along the front and back sides 74, 76 to increase patient comfort and prevent the belt 70 from “cutting” into the patient. The primary strap 72 further includes first and second end portions 92, 94 and a central portion 82 between the end portions 92, 94 where the charger 50 is received and secured to the belt 70, as will be described in further detail below. In one embodiment, the central portion 82 is equidistant from the first and second end portions 92, 94.

As shown in FIG. 5, the back side 76, particularly in the area of the central portion 82, features a fabric 80 with a textured surface that “grips” a contacting surface, i.e., resists free movement relative to the contacting surface, such as a patient's clothing or skin. Thus, the gripping fabric 80 prevents shifting and helps to keep the belt 70 in place. In addition, the primary strap 72 may include a moisture-wicking fabric (not shown), particularly extending along a length of the back side 76, to absorb moisture from the patient. In one embodiment, the gripping fabric 80 is a moisture-wicking fabric.

The central portion 82 includes a pouch 84 into which the charger 50 is inserted. Typically, the charger 50 is inserted such that the operative side of the charger 50, i.e., the side from which the charging energy emits, faces the patient. In the illustrated embodiment, the pouch 84 is formed with a mesh material 85 to allow for dissipation of heat from the charger 50. The pouch 84 may also include an elastic material (not shown) to accommodate different sizes of portable chargers. In one embodiment, the pouch 84 includes a cover flap 86 that folds over to contain the charger 50 and to further protect the charger 50 from external elements, such as moisture from the patient. The cover flap 86 can be secured in place, for example, over the charger 50, with corresponding hook-and-loop fasteners, snaps, ties, or other suitable connectors. In alternative embodiments, instead of a pouch, the charger may be secured to the central portion 82 with elastic bands connected to the central portion 82, corresponding magnets or hook-and-loop fasteners on the charger 50 and central portion 82, or other suitable securing devices. Devices for securing the charger 50 to the belt 70 are also shown in U.S. Publication No. 2009/0082835, which is expressly incorporated herein by reference.

To aid with heat management as the charger 50 operates to charge the IPG 14, in one embodiment, the central portion 82 includes a thermal barrier 88, shown in FIG. 5. For example, the charger 50 may become very warm as it charges the IPG 14, to the point that the patient may experience extreme discomfort and possibly skin burns, even if the patient has the charger 50 positioned on top of clothing. The thermal barrier 88 aids with patient comfort and protects the patient by limiting the amount of heat transferred to the patient's skin. In particular, the thermal barrier 88 is positioned between the charger 50 and the patient, wherein the thermal barrier 88 may be secured to the back side 76 of the primary strap 72, as illustrated in FIG. 5, or alternatively is secured between the charger 50 and the central portion 82. In the illustrated embodiment, the thermal barrier 88 includes a fabric-covered pad, wherein the thermal barrier 88 is secured to the central portion 82 with snaps, hook-and-loop fasteners, or any other suitable securing mechanism, such that the patient can selectively add and remove the thermal barrier 88 as desired. Alternatively, the outline of the thermal barrier 88 may be weakened e.g., by forming cuts around the barrier 88, such that a patient may easily tear the thermal barrier 88 off of the belt 70.

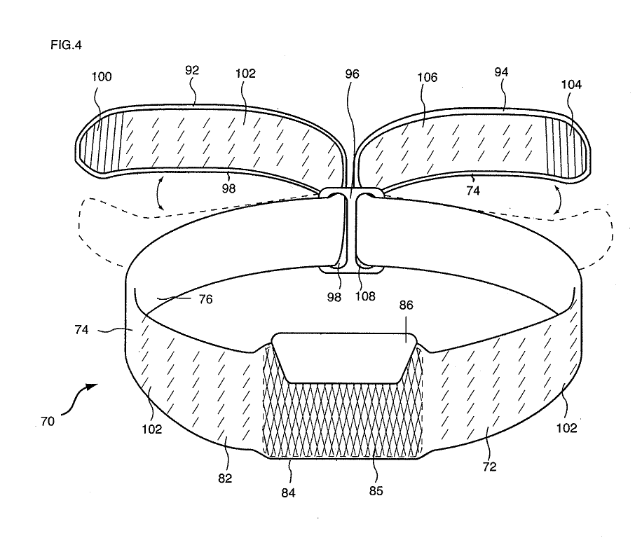

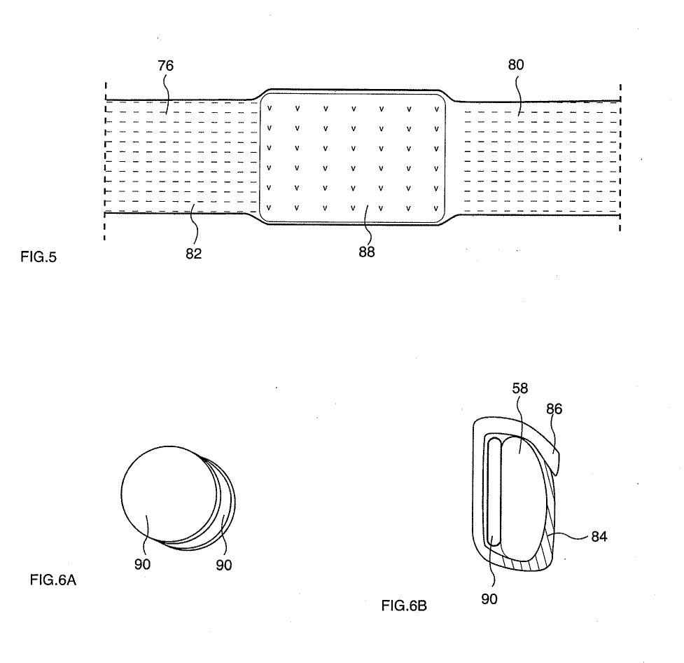

To further provide for heat management and patient comfort, in another embodiment, the belt 70 includes one or more spacers 90, shown in FIG. 6A, that are selectively inserted in the pouch 84 adjacent to the operative side of the charger 50, as shown in FIG. 6B. The spacers 90 increase the distance between the operative side of the charger 50 and the patient in order to reduce the amount of heat transferred to the patient, without significantly affecting charging efficiency. Also, aside from the temperature of the charger 50, if the charger 50 simply feels uncomfortable to the patient, as it typically has a hard, metal surface and/or may be bulky, the spacers 90 provide extra cushion for patient comfort. In one embodiment, the spacers 90 include flexible rubber, such as neoprene, and may alternatively or additionally include a fabric, particulate material (e.g., a powder-filled sack), or gel, among other suitable materials.

The belt 72 further includes a primary buckle 96 with a first opening 98 and a second opening 108. Alternatively, the primary buckle 96 has a single opening (not shown). In addition, first and second fabrics, 100, 102 are disposed along a length of the first end portion 92 on the front side 74 of the primary strap 72 and are configured for being removably adhered to each other. In one embodiment, the first and second fabrics 100, 102 have a hook-and-loop configuration, such as a Cambrelle® and hook configuration.

As illustrated in FIG. 4, the first end portion 92 of the primary strap 72 is slidable through the first opening 98 of the primary buckle 96 to a desired length, and foldable back on itself, such that the first and second fabrics 100, 102 removably adhere to each other. As such, the desired length of the belt 70 is maintained and can later be adjusted by detaching and re-adhering the first and second fabrics 100, 102. In this manner, a convenient means of adjusting and readjusting the length of the belt 70 is provided to achieve a comfortable yet secure fit, the adjusted length of the belt 70 being measured as the length between the tip of the second end portion 94 of the primary strap 72 and the end of the primary buckle 96 when the first end portion 92 of the primary strap 72 is folded back on and adhered to itself.

Thus, unlike other devices that hold a portable charger, there is no need to cut the belt 70 to achieve an optimal fit on a patient. Instead, the patient only needs to maneuver the first end portion 92 to achieve a desired length of the belt 70. This presents an economical aspect—specifically, if the patient loses or gains weight, which is not uncommon during various types of medical treatment procedures that employ implanted chargeable devices, the adjustable features of the belt 70 eliminate the need for the patient to buy a new belt. With other types of devices, the patient may have to purchase a new device to replace a previous device that was cut or otherwise altered for a different fit. Further, the adjustability of the belt 70 allows for use on different body parts. For example, if a patient needs to charge both a device implanted in the patient's ankle and a device implanted in the patient's back, the patient only needs to adjust the belt 70 to fit each body part, instead of employing multiple devices.

The second end portion 94 is also insertable through the primary buckle 96 to secure the belt 70 around the selected body part of the patient, as shown in FIG. 4. Specifically, the second end portion 94 is slid through the second opening 108 of the primary buckle 96 and folded back on itself to secure the belt 70 in position around the selected body part of the patient. To this end, in a further embodiment, third and fourth fabrics 104, 106 are disposed along a length of the second end portion 94 and are configured for being removably adhered to each other, wherein the second end portion 94 is slid through the primary buckle 96 and folded back on itself to adhere the third and fourth fabrics 104, 106 together. Of note, the third and fourth fabrics 104, 106 may be different from, or the same as, first and second fabrics 100, 102, respectively. Alternatively, if only one opening is provided in the primary buckle 96, both the first end portion 92 and the second end portion 94 can be slid through the same opening.

In the illustrated embodiment, the terminating ends of the first and second end portions 92, 94 are tapered for minimizing overlapping edges and easier handling. In alternative embodiments, instead of adhering first and second fabrics 100, 102 together, the first end portion 92 can be folded upon itself and secured in place with metal or plastic hooks and loops, snaps, magnets, buttons and buttonholes, or other suitable securing devices.

Of note, while the first end portion 92 is described herein for adjusting the length of the belt 70 and the second end portion 94 is described herein for securing the belt 70 around the patient, the patient may use the second end portion 94 to adjust the length of the belt 70 and the first end portion 92 to secure the belt 70. Similarly, the patient may use the second end portion 94 to adjust the position of the primary buckle 96, e.g., by sliding the second end portion 94 through the primary buckle 96 to position the primary buckle 96 in a desired area relative to the pouch 84, and then folding the second end portion 94 back on itself to adhere third and fourth fabrics 104, 106 together to secure the position of the primary buckle 96. Advantageously, selectively slipping the first end portion 92 or the second end portion 94 of the primary strap 72 allows the patient to select the side of the belt 70 where the primary buckle 96 is located to match up with the hand that the patient typically uses to grasp a belt buckle. Further, this is helpful for patients who are incapacitated on one side of their body, since the primary buckle 96 can be positioned on either side of the body, e.g., the side of a patient's body that is most functional.

In addition to making the length of the belt 70 adjustable and readjustable and selecting the side of the belt 70 to which the primary buckle 96 will be coupled prior to securing the belt 70 to the patient, the ability to slide the first end portion 92 or the second end portion 94 of the primary strap 72 through the first opening 98 of the primary buckle 96 and fold it back and adhere to itself conveniently allows the position of the primary buckle 96 relative to the pouch 84 to be adjusted, thereby allowing the pouch 84, and thus the charger 50, to be aligned with the IPG 14 when the primary buckle 96 is held in hand just prior to securing the belt 70 to the patient. As such, the patient can repeatedly and consistently position the primary buckle 96 at the same location where it is easy for the patient to handle the belt 70 and secure the belt 70 around the patient, while still aligning the pouch 84, and thus the charger 50, with the IPG 14. For example, if the patient prefers to put the belt 70 on while holding the primary buckle 96 in the left hand, the patient can slide the first end portion 92 through the primary buckle 96 to a specific length that aligns the charger 50 with the IPG 14 when the primary buckle 96, after the first end portion 92 has been folded back and adhered to itself, is held in the patient's left hand at a ergonomically convenient location relative to the waist. It can be appreciated from the foregoing of the ability to adjust the primary buckle 96 relative to the pouch 84 that allows the charger 50 to be aligned with the IPG 14 wherever implanted relative to the waist.

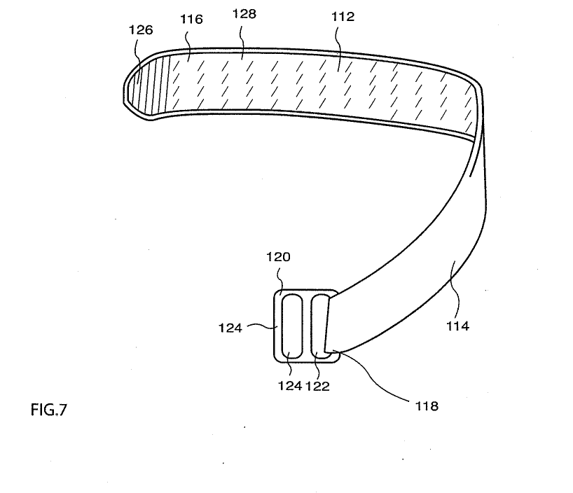

Now referring to FIGS. 7 and 8, the belt 70 optionally includes a secondary strap 110 that essentially serves as an extension to the primary strap 72. To this end, the secondary strap 110 has third and fourth opposing sides 112, 114, wherein the third side 112, or front side, faces outwardly from the patient, and the fourth side 114, or back side, faces toward the patient. The secondary strap 110 also has third and fourth end portions 116, 118, wherein the fourth end portion 118 is attached to a secondary buckle 120 through a first opening 122 of the secondary buckle 120. The secondary buckle 120 further includes a second opening 124 for receiving an end of the primary strap 72, which will be described in more detail below. Fifth and sixth fabrics 126, 128 are disposed along a length of the third end portion 116 on the front side 112 and are configured for being removably adhered to each other. Of note, the fifth and sixth fabrics 126, 128 may be different from, or the same as, first and second fabrics 100, 102, or the third and fourth fabrics 104, 106, respectively.

In this embodiment, the third end portion 116 can be slid through the primary buckle 96, as shown in FIG. 8, and then folded back on itself such that the fifth and sixth fabrics 126, 128 adhere together, thus joining the primary strap 72 and the secondary strap 110, while further extending and/or adjusting the length of the belt 70. Also, the third end portion 116 can be slid through the primary buckle 96 to adjust the position of the secondary buckle 120 relative to the pouch 84. The second end portion 94 of the primary strap 72 is then slidable through the secondary buckle 120 to secure the belt 70 around a body part of a patient, e.g., by folding the second end portion 94 back on itself and adhering third and fourth fabrics 104, 106 together.

Having described the structure and function of the belt 70, a method of using the belt 70 with the charger 50 and IPG 14 will now be described. Typically, the patient first adjusts the belt 70 to a configuration that achieves a desirable fit and ease of use for the patient. This includes adjusting the length of the belt 70 and may further include adjusting the position of the primary buckle 96 relative to the pouch 84. Specifically, the position of the primary buckle 96 is adjusted such that the primary buckle 96 is located where the patient can easily handle the buckle 96, while still consistently aligning the pouch 84 with the IPG 14.

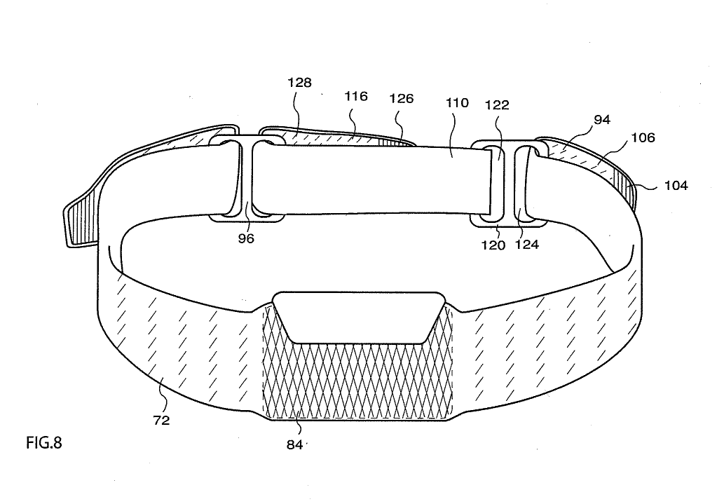

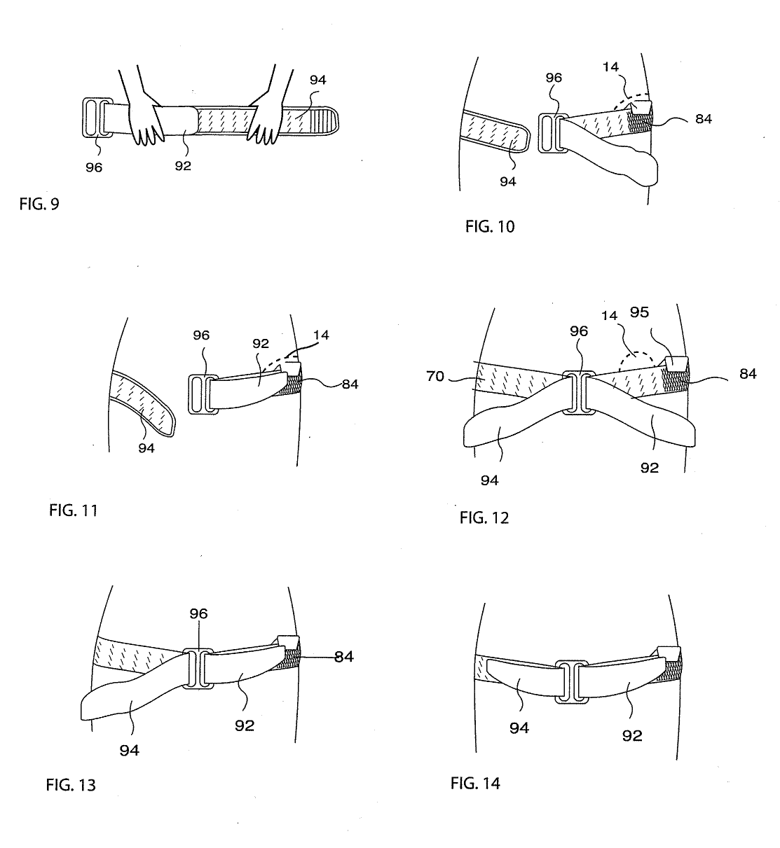

As shown in FIG. 9, one way for the patient to adjust the length of the belt 70 is to simply hold the belt 70 in front of his body, i.e., prior to putting the belt 70 around a body part, insert the first end portion 92 into the first opening 92 of the primary buckle 96, and then pull it through the primary buckle 96 to a desired length. At the same time, the patient may further adjust the position of the primary buckle 96 relative to the pouch 84 by positioning the primary buckle 96 along the primary strap 72 to where the patient feels the primary buckle 96 will be convenient to handle. The patient then folds the first end portion 92 on itself to adhere the first and second fabrics 100, 102 together. The patient may alternatively use the second end portion 94 to change the configuration of the belt 70 in the same manner as just described, with the exception that the second end portion 92 is inserted into and then pulled through the first opening 92 of the primary buckle 96, and then folded onto itself to adhere the third and fourth fabrics 104, 106 together.

In another method of adjusting the configuration of the belt 70, shown in FIG. 10, the patient positions the belt 70 around a selected body part (in this case, the waist of the patient) with the pouch 84 aligned with the IPG 14, inserts the first end portion 92 into the first opening 92 of the primary buckle 96, and then pulls it through the primary buckle 96 to a desired length. At the same time, the patient may further adjust the position of the primary buckle 96 relative to the pouch 84 by positioning the primary buckle 96 along the primary strap 72 to where the patient feels the primary buckle 96 will be convenient to handle while keeping the pouch 84 aligned with the IPG 14. When the length of the belt 70 and the primary buckle 96 are adjusted to suit the patient, the patient folds the first end portion 92 on itself to adhere the first and second fabrics 100, 102 together, as shown in FIG. 11, to maintain the desired configuration of the belt 70. The patient may alternatively use the second end portion 94 to change the configuration of the belt 70 in the same manner as just described, with the exception that the second end portion 92 is inserted into and then pulled through the first opening 92 of the primary buckle 96, and then folded onto itself to adhere the third and fourth fabrics 104, 106 together.

In yet another method of adjusting the configuration of the belt 70, shown in FIG. 12, the patient positions the belt 70 around a selected body part (in this case, the waist of the patient) with the pouch 84 aligned with the IPG 14. The patient inserts the first end portion 92 into the first opening 92 of the primary buckle 96, and then pulls the first end portion 92 through the first opening 98 of the primary buckle 96. The patient also inserts and then pulls the second end portion 94 through the second opening 108 of the primary buckle 96 to help stabilize the belt 70 around the patient's waist.

The patient then uses the left hand to pull the first end portion 92 through the first opening 98, while slacking the second end portion 94 in the patient's right hand, such that the primary buckle 96 slides along the primary strap 72 toward the pouch 84 on the patient's left side while keeping the pouch 84 aligned with the IPG 14. When the desired length of the belt 70 and position of the primary buckle 96 are achieved, the patient folds the first end portion 92 on itself to adhere first and second fabrics 100, 102, as shown in FIG. 13, to maintain the desired configuration of the belt 70. To secure the belt 70 to the patient, the patient also folds the second end portion 94 on itself to adhere third and fourth fabrics 104, 106, as shown in FIG. 14.

Alternatively, the patient may use the right hand to pull the second end portion 94 through the second opening 98, while slacking the first end portion 92 in the patient's left hand, such that the primary buckle 96 slides along the primary strap 72 toward the pouch 84 on the patient's right side while keeping the pouch 84 aligned with the IPG 14. The patient can then fold the second end portion 92 on itself to adhere third and fourth 104, 106 to maintain the desired configuration of the belt 70. To secure the belt 70 to the patient, the patient will then fold the first end portion 92 on itself to adhere first and second fabrics 100, 102.

Significantly, with this method, the patient can readily alternate between pulling the first end portion 92 with the left hand and pulling the second end portion 94 with the right hand to adjust the position of the primary buckle 96, and to further adjust the length of the belt 70, if needed. Also, since the primary buckle 96 can be easily shifted back and forth between the patient's right and left sides, the patient can alternately select which of the end portions, 92 or 94, stays folded on itself to maintain the configuration of the belt 70, while the other of the end portions 92, 94 is detached and reattached and pulled back and forth through the primary buckle 96 for taking off and removing the belt 70.

If further adjustments to the configuration of the belt 70 are needed, the patient detaches the first and second fabrics 100, 102 and pulls the first end portion 92 through the primary buckle 96 to further adjust the length of the belt 70 and the position of the primary buckle 96 as desired. Afterward, the patient folds the first end portion 92 on itself and adheres first and second fabrics 100, 102 together. The third and fourth fabrics 104, 106 of the second end portion 94 may also be detached and reattached if the patient wishes to pull the second end portion 94 through the primary buckle 96 to make adjustments to the belt 70. In this manner, the patient may make several adjustments to the length of the belt 70 whenever, needed, for example, to accommodate changes in weight and/or additional layers of clothing, without having to damage the belt 70 or acquire a new belt 70.

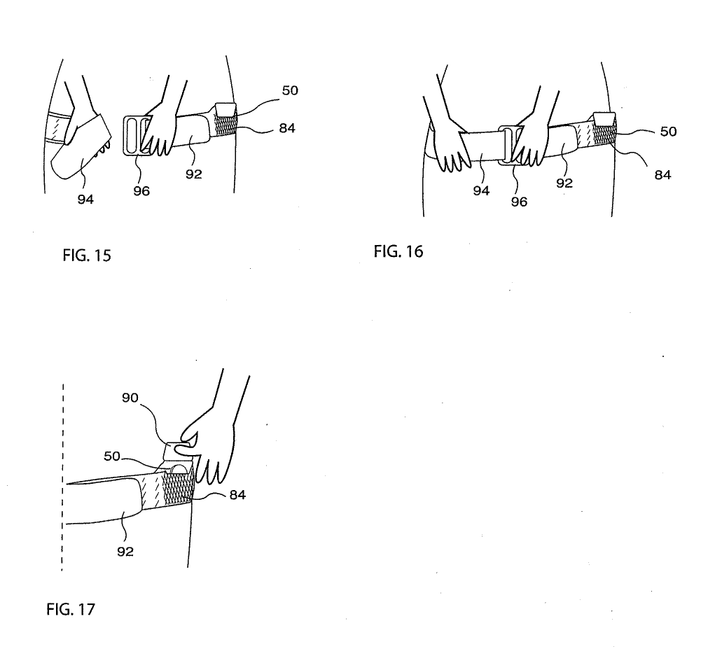

Once the belt 70 is adjusted to the desired length, and the primary buckle 96 is adjusted to a convenient position relative to the pouch 84, the belt 70 can repeatedly be placed on and removed from the patient while consistently keeping the primary buckle 96 and the pouch 84 in the same position for the patient's comfort and ease of use. To place the belt 70 on the patient to charge the IPG 14, the patient places the belt 70 around the patient's waist, as shown in FIG. 15 and aligns the pouch 84 with the IPG 14. For purposes of illustration, the charger 50 is shown inserted in the pouch 84 when the belt 70 is first positioned around the patient's waist, but the patient may insert the charger 50 in the pouch 84 at any point that is suitable for the patient. The patient then pulls the second end portion 94 through the primary buckle 96 and folds the second end portion 94 on itself to adhere third and fourth fabrics 104, 106 together, as shown in FIG. 16.

In this manner, the belt 70 is secured around the patient, while the pouch 84 holding the charger 50 is maintained in a consistent position relative to the primary buckle 96 and in alignment with the IPG 14. Also, the length of the belt 70 and position of the primary buckle 96 are consistently suitable for the patient. Further, the patient does not have to make any further adjustments to the belt 70 to align the pouch 84 with the IPG 14.

After the charger 50 is aligned with the IPG 14, the external charger 50 will then begin transcutaneously transmitting electrical energy through the charger 50 to charge the implanted IPG 14. During this time, the charger 50 may become hot and uncomfortable for the patient. In this instance, the thermal barrier 88 helps to minimize the amount of heat transferred to the patient. If the thermal barrier 88 is not already secured to the belt 70, the patient can selectively attach the thermal barrier 88 to the central portion 82. Alternatively, the thermal barrier 88 is inserted between the charger 50 and the central portion 82, e.g., in the pouch 84 adjacent to the operative side of the charger 50. To further manage patient comfort, as shown in FIG. 17, the patient may insert one or more spacers 90 in the pouch 84 adjacent to the operative side of the charger 50. The patient can add and remove a number of spacers 90 as desired before the charger 50 is operating or during the charging process, to achieve optimum comfort.

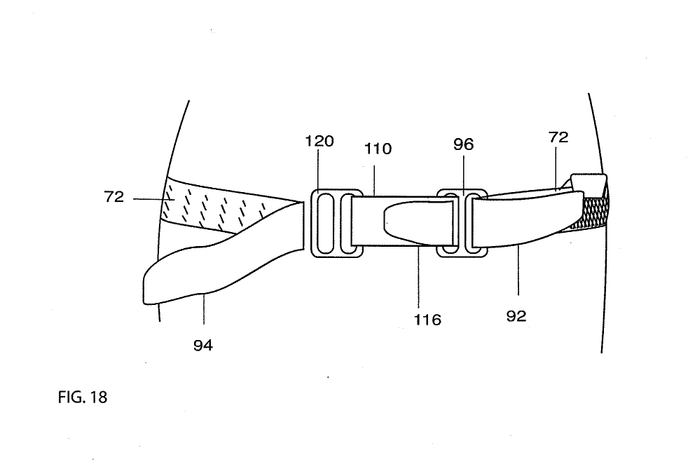

In the case where the belt 70 includes the optional secondary strap 110, the secondary strap 110 is joined with the primary strap 72 to extend the length of the belt 70, as shown in FIG. 18. In particular, the first end portion 92 is inserted and pulled through the primary buckle 96 and folded over on itself to adhere first and second fabrics 100, 102 together, after which the third end portion 116 of the secondary strap 110 is also inserted and pulled through the primary buckle 96 and folded over on itself to adhere the fifth and sixth fabrics 126, 128 together. In this manner, the primary strap 72 and secondary strap 110 are joined together and the length of the belt 70 is increased. Alternatively, the second end portion 94 is inserted and pulled through the secondary buckle 120 and folded over on itself to adhere third and fourth fabrics 104, 106, and then the third portion 116 of the secondary strap 110 is inserted and pulled through the primary buckle 96 and folded over on itself to adhere the fifth and sixth fabrics 100, 102 together, thereby joining the primary strap 72 and secondary strap 110 together.

In this embodiment, the patient may first select which of the primary and second buckles 96, 120 the patient will use to put on and take off the belt 70. Then the patient can adjust the length of the belt 70 and the position of the selected buckle by pulling the respective end portions of the belt 70 through the selected buckle as needed. For example, if the patient wishes to use the secondary buckle 120 for repeatedly putting on and taking off the belt 70, the patient adjusts the length of the belt 70 by inserting and pulling the first end portion 92 and/or the third end portion 116 through the primary buckle 96 and folds the respective end portions 92, 116 back on themselves to maintain the length of the belt 70. To adjust the position of the secondary buckle 120 relative to the pouch 84, the patient holds the first end portion 92 in the left hand and selectively pulls the first end portion 92 through the primary buckle 96, while holding the second end portion 94 in the left hand and selectively pulling the second end portion 94 through the secondary buckle 120, similar to the method described above. If the patient wishes to use the primary buckle 96 for putting on and removing the belt 70, the patient may also adjust the length of the belt 70 and the position of the primary buckle 96 using the second end portion 94 and either of the first and third end portions 92, 116 in the same manner.

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. Thus, the present inventions are intended to cover alternatives, modifications, and equivalents, which may be included within the spirit and scope of the present inventions as defined by the claims.

What is claimed is:

1. A belt having an adjustable length for securing an external device having an operative side from which energy can be transmitted to a medical device implanted within a patient, comprising:
a primary strap configured for encircling a body part of the patient, the primary strap having first and second opposing sides, a first end portion, a second end portion, and a central portion between the first and second end portions to which the external device can be secured, such that the operative side of the external device faces the patient;
first and second fabrics disposed on the first side of the primary strap respectively along a length of the first end portion, wherein the first and second fabrics are configured for being removably adhered to each other; and
a primary buckle having a first opening through which the first end portion of the primary strap can be slid and folded back onto itself, such that the first fabric adheres to the second fabric to adjust the length of the belt, the primary buckle configured for receiving the second end portion of the primary strap to secure the belt to the body part of the patient.

2. The belt of claim 1, further comprising third and fourth fabrics disposed on the first side of the primary strap respectively along a length of the second end portion, wherein the third and fourth fabrics are configured for being removably adhered to each other, and the second end portion of the primary strap is configured for being slid through the primary buckle and folded back onto itself, such that the third fabric adheres to the fourth fabric to secure the belt to the body part of the patient.

3. The belt of claim 2, wherein the primary buckle includes a second opening through which the second end portion can be slid.

4. The belt of claim 1, wherein the first and second fabrics are configured for being removably adhered to each other using a hook-and-loop configuration.

5. The belt of claim 1, further comprising a pouch configured for receiving the external device to secure the external device to the central portion.

6. The belt of claim 5, further comprising one or more selectively removable spacers configured for being located within the pouch to increase the distance between the operative side of the external device within the pouch and the patient.

7. The belt of claim 1, further comprising a thermal barrier secured to the central portion, such that the thermal barrier is located between the external device and the patient when the belt is secured to the body part of the patient, wherein the thermal barrier is selectively removable by the patient.

8. The belt of claim 1, further comprising a gripping fabric disposed on the second side of the primary strap, thereby limiting movement of the belt relative to the patient.

9. The belt of claim 1, wherein the body party is a waist of the patient.

10. The belt of claim 1, wherein the central portion is equidistant between the first and second end portions of the primary strap.

11. The belt of claim 1, further comprising:
a secondary strap having third and fourth opposing sides, a third end portion, and a fourth end portion;
fifth and sixth fabrics disposed on the third side of the secondary strap respectively along a length of the third end portion of the secondary strap, wherein the fifth and sixth fabrics are configured for being removably adhered to each other, and the third end portion of the secondary strap is configured for being slid through the primary buckle and folded back onto itself, such that the fifth fabric adheres to the sixth fabric to secure the secondary strap to the primary strap; and
a secondary buckle attached to the fourth end portion and configured for receiving the second end portion of the primary strap to secure the belt to the body part of the patient.

12. A method for using a belt having a primary strap and a primary buckle to secure an external device to a patient having an implanted medical device, comprising:
sliding one of first and second end portions of the primary strap through a first opening of the primary buckle;
folding the one end portion of the primary strap back onto itself after it has been slid through the first opening of the primary buckle, thereby adjusting the length of the belt;
removably adhering the folded one end portion of the primary strap to itself to affix the adjusted length of the belt;
securing the external device to the primary strap;
substantially encircling a body part of the patient with the primary strap of the belt with the adjusted length, such that an operative side of the secured external device from which energy is transmitted is located in proximity to the implanted medical device; and
sliding another of the first and second end portions of the primary strap through the primary buckle to secure the belt to the body part of the patient.

13. The method of claim 12, further comprising:
folding the other end portion of the primary strap back on itself after it has been slid through the primary buckle; and
removably adhering the folded other end portion of the primary strap to itself to secure the belt to the body part of the patient.

14. The method of claim 13, wherein the other end portion of the primary strap is slid through a second opening of the primary buckle.

15. The method of claim 12, wherein the implanted medical device is located on one side of the body, and the first or second end portion of the primary strap is selected as the one end portion of the primary strap to bias the external device in the direction of the implanted medical device when the belt is secured to the body part of the patient.

16. The method of claim 12, wherein the belt further comprises a pouch, and the external device is secured to the belt by inserting the external device in the pouch.

17. The method of claim 16, further comprising positioning one or more spacers in the pouch, thereby increasing the distance between the operative side of the external device within the pouch and the patient.

18. The method of claim 12, further comprising removing a thermal barrier previously secured to the strap between the external device and the patient.

19. The method of claim 12, wherein the body party is a waist of the patient.

20. The method of claim 12, wherein the external device is secured to the primary strap equidistant between the first and second ends of the primary strap.

21. The method of claim 12, further comprising transmitting the energy from the external device to the implanted medical device.

22. The method of claim 21, wherein the energy is charging energy.
